(19) United States
(12) Patent Application Publication
(10) Pub. No.: US 2018/0361178 A1
(43) Pub. Date: Dec. 20, 2018

(54) GLASS SMASHER WITH RAPIDLY REMOVABLE PROTECTIVE COVER

(71) Applicant: KANTAS PRODUCTS CO., LTD., Taipei City (TW)

(72) Inventor: Yang-Fu CHENG, Taipei City (TW)

(73) Assignee: KANTAS PRODUCTS CO., LTD., Taipei City (TW)

(21) Appl. No.: 15/834,236

(22) Filed: Dec. 7, 2017

(30) Foreign Application Priority Data
Jun. 15, 2017 (TW) 106120017
Aug. 31, 2017 (TW) 106129792

(51) Int. Cl. A62B 3/00; F41B 15/02

(52) U.S. Cl. CPC A62B 3/005; F41B 15/025

(57) ABSTRACT

A glass smasher with a rapidly removable protective cover is mounted at one end of a portable object. When a user holds the portable object and presses the front end (i.e., the smashing cone) of the smashing rod of the glass smasher forcibly against a to-be-smashed glass obstacle, the rear section of the smashing rod will be struck such that the smashing cone is instantly driven to smash the glass obstacle. The protective cover can be mounted around the front end of the glass smasher to store the entire smashing cone in the protective cover. When the protective cover is not pulled, the sliding sleeve of the protective cover is pushed by a packing spring and hence pushes a plurality of engaging elements into engagement in the engaging groove of the glass smasher, thereby preventing the protective cover from inadvertent detachment from the front end of the glass smasher.

### FIELD OF THE INVENTION

The present invention relates to a glass smasher and more particularly to one with a rapidly removable protective cover.

### BACKGROUND OF THE INVENTION

Thanks to technological advancements, the development of glass materials has reached a highly mature state, giving rise to various types of glass that have different physical properties and applications, such as safety glass, tempered glass, thermally stable glass, low-expansion glass, and laminated glass, to name only a few. These new types of glass have enhanced the quality of our daily lives but also form blind spots in terms of safety. For instance, doors and car windows made of tempered glass, which cannot be rapidly smashed without a proper tool, tend to hinder escape from a house, car, or other glass-enclosed environment where an accident (e.g., a fire or car crash) takes place. In addition, the sharp broken pieces of such tempered-glass obstacles are hard to remove and may therefore delay escape or rescue or even lead to tragic consequences.

Take tempered glass and safety glass, which have high structural strength and are widely used nowadays in public transportation (e.g., busses and streetcars) and buildings, for example. Such a glass material is so difficult to smash that a police officer, firefighter, or rescue team member striking it with a hammer, bat, or other heavy object may be injured by the massive recoil of the striking tool in use. Generally speaking, only by hitting the glass material perpendicularly and vigorously with a pointed heavy object can the cohesive force in the glass material be effectively reduced to such extent that the glass material eventually breaks. Currently, referring to FIG. 1, the market is supplied with a portable tool 11 (e.g., a baton or flashlight) for use by the police and the fire departments to smash glass obstacles, wherein the tool 11 is mounted with a smashing cone 10. When a police officer or firefighter carrying out an emergency rescue operation or raid encounters an obstacle 12 made of strong glass, he or she can take out the tool 11 immediately and hit the glass obstacle 12 with the smashing cone 10 in order to reduce the cohesive force within the glass obstacle 12, thereby forming a breaking point in, and consequently shattering, the glass obstacle 12 to facilitate the rescue or attack.

In use, however, the tool 11 leaves plenty of room for improvement. One major drawback lies in the fact that the smashing cone 10 is typically fixed at one end (e.g., the front or rear end) of the tool 11 in order to be portable along with the tool 11, and that therefore one who uses the tool 11 in an emergency rescue operation or raid must hold the tool 11 with the thumb facing themselves (see FIG. 1) in order to apply a force to the smashing cone 10 and hit the glass obstacle 12 repeatedly. Nevertheless, the way the tool 11 is held makes it difficult not only for the user to exert a force on the smashing cone 10, but also for the user to strike precisely the same spot on the glass obstacle 12 while moving the smashing cone 10 back and forth. As a result, the cohesive force within the glass obstacle 12 may stay intact even though the user has made great physical efforts, and failure to smash the glass obstacle 12 in time may bring about failure of the intended rescue or attack.

To overcome the foregoing drawbacks, the inventor of the present invention designed a novel expandable baton 2 as shown in FIG. 2. The expandable baton 2 is compact in size, can be easily carried around by a police officer or firefighter for self-defense, and can be expanded whenever needed in an emergency rescue or attack. Simply by holding the handle of the expandable baton 2, a user can apply a force to precisely the same spot on a robust glass obstacle over and over again through the smasher 4 at the front end of the expandable baton 2, in order for the smasher 4 to build up a striking force large enough to dissolve the cohesive force in the glass obstacle. As shown in FIG. 2, the expandable baton 2 includes an outer tube 21 and at least one inner shaft 22. The outer tube 21 and the inner shaft 22 form the basic structure of the expandable baton 2. The rear section of the outer tube 21 forms a handle to be gripped by a user. The outer diameter of the inner shaft 22 is smaller than the inner diameter of the outer tube 21 so that the inner shaft 22 can be moved, and thus mounted, into the outer tube 21 through the rear end of the outer tuber 21. In addition, the configuration of the rear end portion 22a of the inner shaft 22 matches the configuration of a portion of the outer tube 21 that is adjacent to the front end portion 21a of the outer tube 21. For example, the rear end portion 22a of the inner shaft 22 flares a little while the front end portion 21a of the outer tube 21 converges slightly to enable engagement between the two end portions. When the inner shaft 22 is displaced outward of the front end portion 21a of the outer tube 21 such that the rear end portion 22a of the inner shaft 22 reaches a position in the outer tube 21 that is adjacent to the front end portion 21a of the outer tube 21, the outer wall of the rear end portion 22a of the inner shaft 22 is engaged with an inner wall portion of the outer tube 21 that is adjacent to the front end portion 21a of the outer tube 21. As a result, the entire inner shaft 22 is exposed from the front end portion 21a of the outer tube 21 except for the portion adjacent to the rear end portion 22a of the inner shaft 22, which portion is now secured in the outer tube 21. Conversely, when the inner shaft 22 is stored in the outer tube 21, the rear end portion 22a of the inner shaft 22 is secured by an engaging member 21b in the rear end of the outer tube 21, leaving only the front end of the inner shaft 22 exposed from the front end portion 21a of the outer tube 21.

Referring to FIG. 3A in conjunction with FIG. 2, the smasher 4 is provided at the front end of the inner shaft 22 (or the front end of the innermost inner shaft 22 if the expandable baton 2 has several inner shafts 22) and includes a base 40, an eccentric spring 413, an impact block 43, a compression spring 44, and a smashing rod 45. The base 40 is coupled to the front end of the inner shaft 22 such that the base 40 and the inner shaft 22 form a single unit. An impact groove 41, a tapering groove 411, an aligning groove 412, and a compression force application groove 42 are sequentially formed, in a front-to-rear direction, in the base 40 and the front end of the inner shaft 22 and are in communication with one another. The front end of the base 40 is formed with an aperture 410. The aperture 410 is in communication sequentially with the impact groove 41, the tapering groove 411, the aligning groove 412, and the compression force application groove 42 and has a smaller diameter than the impact groove 41. The tapering groove 411 extends taperingly from the rear end of the impact groove 41 to the front end of the aligning groove 412, and the wall of the tapering groove 411 forms a first tapering pressing surface 4110. The diameter of the aligning groove 412 is smaller than those of the impact groove 41 and of the compression force application groove 42.

As shown in FIG. 3A, the impact block 43 is movably positioned in the compression force application groove 42. The front end of the impact block 43 can be pressed against the wall of the compression force application groove 42 (e.g., a portion of the compression force application groove 42 that is adjacent to the aligning groove 412) and is concavely provided with a striking groove 430. The striking groove 430 corresponds to the aligning groove 412 and has a smaller diameter than the aligning groove 412. The compression spring 44 is positioned in the compression force application groove 42 and has its two ends pressed respectively against the rear end of the impact block 43 and a wall portion of the compression force application groove 42 that is away from the aligning groove 412, in order to push the impact block 43 toward the aligning groove 412. To facilitate description of the structural features and striking principle of the smashing rod 45, the smashing rod 45 is hereinafter divided into a front section 450, a middle section 451, and a rear section 452. The front section 450 of the smashing rod 45 is formed with a smashing cone 4501. The middle section 451 matches the aligning groove 412 in diameter, and a wall portion of the middle section 451 that is adjacent to the rear section 452 forms a second tapering pressing surface 453. Normally, the axis of the smashing rod 45 is offset from the axis of the impact block 43 such that the rear end of the rear section 452 of the smashing rod 45 is pressed against the front end of the impact block 43 to prevent the rear section 452 of the smashing rod 45 from extending into the striking groove 430. Thus, with the front end of the impact block 43 pushing back at the rear end of the rear section 452 of the smashing rod 45, the smashing rod 45 is positioned in the impact groove 41, the tapering groove 411, and the aligning groove 412, with the smashing cone 4501 exposed from the front end of the smasher 4 through the aperture 410.

With continued reference to FIG. 3A, the eccentric spring 413 is mounted around the periphery of the middle section 451 of the smashing rod 45 and is positioned in the impact groove 41 and the tapering groove 411. In this embodiment, the eccentric spring 413 is mounted around the middle section 451 of the smashing rod 45 and has its two ends pressed respectively against a portion of the smashing rod 45 that is adjacent to the front section 450 and the wall of the tapering groove 411 (i.e., the first tapering pressing surface 4110), in order to push the front section 450 of the smashing rod 45 outward of the aperture 410, thereby exposing the smashing cone 4501 of the front section 450 of the smashing rod 45 from the front end of the smasher 4. The elastic force of the eccentric spring 413 must be smaller than that of the compression spring 44 so that, as soon as the rear section 452 of the smashing rod 45 is in alignment with the striking groove 430, as shown in FIG. 3B, the impact block 43 will strike the rear end of the rear section 452 of the smashing rod 45 under the action of the compression spring 44, and when the smashing cone 4501 of the front section 450 of the smashing rod 45 completes the intended striking and smashing action, the eccentric spring 413 will render the axis of the smashing rod 45 offset from the axis of the impact block 43, thereby moving the rear end of the rear section 452 of the smashing rod 45 away from the striking groove 430 and back to the position shown in FIG. 3A, i.e., pressed against the front end of the impact block 43.

Referring to FIGS. 3A and 3B in conjunction with FIG. 2, when a user holding the expandable baton 2 presses the smashing cone 4501 forcibly against a to-be-smashed object (e.g., a piece of tempered glass), the smashing rod 45 is gradually displaced toward the compression force application groove 42. When the second tapering pressing surface 453 of the wall of the middle section 451 of the smashing rod 45 is pressed against the first tapering pressing surface 4110, the middle section 451 of the smashing rod 45 begins to be guided by the aligning groove 412 into alignment with the axis of the impact block 43. Now that the middle section 451 of the smashing rod 45 matches the aligning groove 412 in diameter, the instant at which the middle section 451 becomes perfectly aligned with the striking groove 430 (i.e., enters the state shown in FIG. 3B), the rear section 452 of the smashing rod 45 thrusts into the striking groove 430, allowing the huge elastic force stored in the compression spring 44 to push the impact block 43 outward. The impact block 43 will in turn strike the rear end of the smashing rod 45, thereby driving the smashing cone 4501 at the front end of the smashing rod 45 to smash the to-be-smashed object vigorously. Thus, by equipping the expandable baton 2 with the smasher 4, the functions and applications of the expandable baton 2 are increased.

After actually making the expandable baton 2, however, the inventor found it necessary to cover the pointed structure of the smashing cone 4501 because the elastic forces applied by the eccentric spring 413 and by the compression spring 44 will keep the smashing cone 4501 of the front section 450 of the smashing rod 45 exposed from the front end of the smasher 4. If the smashing cone 4501 is left uncovered, one who carries or is using the expandable baton 2 is very likely to be punctured or scratched by the smashing cone 4501, or injure people nearby, or cause damage to neighboring objects. In the light of this, the inventor came up with the idea of locking a threaded protective cover 46 (see FIG. 3A) to the outer periphery of the front end of the smasher 4 threadedly, in order for the threaded protective cover 46 to accommodate and hide the pointed structure of the smashing cone 4501. Nevertheless, this improvement still leaves something to be desired. After using the improved expandable baton 2 repeatedly, the inventor found that, although the threaded protective cover 46 is capable of covering the pointed structure of the smashing cone 4501, it may detach from the front end of the smasher 4 when the expandable baton 2 is forcibly swung in order to be used in the expanded state, should the user only cover the smashing cone 4501 with the threaded protective cover 46 but fail to lock the threaded protective cover 46 securely to the outer periphery of the front end of the smasher 4 in the first place, either inadvertently or otherwise, e.g., due to a damage of the related threads. The detached threaded protective cover 46 may hurt people (or damage objects) in front the user when flying off the smasher 4. If, on the other hand, the threaded protective cover 46 is locked firmly to the outer periphery of the front end of the smasher 4, the user may have problem unscrewing the threaded protective cover 46 from the front end of the smasher 4 promptly during an emergency rescue or raid; this is especially true under the pressure of time or when in a hurry. As a result, the perfect timing for effective rescue or attack could be lost, and failure to smash a glass obstacle 12 in time may put a tragic end to the rescue or attack.

In view of the above, the inventor of the present invention aimed to design a novel glass smasher having a rapidly removable protective cover. The issue to be addressed by the present invention is to render this glass smasher applicable to one end of a portable object (e.g., a baton, flashlight, hand tool, or tactical pen) and ensure that the glass smasher not only has a compact structure, allowing the portable object to be carried around safely by a police officer of firefighter and perform its functions, but also is readily usable during an emergency rescue operation or raid, with the rapidly removable protective cover swiftly detachable from the front end of the glass smasher to expose the smashing cone of the front section of the smashing rod in the glass smasher from the front end of the smasher as soon as possible. Thus, a police officer or firefighter only has to hold the portable object and press the smashing cone repeatedly against the same spot on a robust glass obstacle, and the smasher will build up a striking force large enough to dissolve the cohesive force in the glass obstacle and thereby break the glass obstacle effectively.

### BRIEF SUMMARY OF THE INVENTION

Considering the various deficiencies and problems associated with the use of the foregoing conventional tools designed for the police and the fire departments, the inventor of the present invention incorporated years of practical experience in the research and development of related tools into an extensive study and repeated tests and finally succeeded in developing a glass smasher with a rapidly removable protective cover as disclosed herein. The present invention is intended to solve all the aforementioned drawbacks of the prior art and greatly increase the speed, efficiency, and success rate of any rescue operation or attack where the glass smasher is applicable.

One objective of the present invention is to provide a glass smasher having a rapidly removable protective cover. The glass smasher is applied to a portable object (e.g., a baton, flashlight, hand tool, or tactical pen) and is mounted at one end (e.g., a front/upper/top end or a rear/lower/bottom end) of the portable object. The glass smasher includes a base, a smashing rod, an eccentric spring, an impact block, and a compression spring. The base is coupled to the aforesaid end of the portable object such that the base and the portable object form a single unit. The outer periphery of the base is circumferentially and concavely provided with an engaging groove adjacent to the front end of the base. An impact groove, a tapering groove, an aligning groove, and a compression force application groove are sequentially formed, in a front-to-rear direction, in the base. The impact block is provided in the compression force application groove and is pushed toward the impact groove by the compression spring such that the smashing rod is positioned in the impact groove, the aligning groove, and the tapering groove, with the smashing cone of the front section of the smashing rod exposed from the front end of the glass smasher. When a user holds the portable object and presses the front end of the smashing cone forcibly against a to-be-smashed glass obstacle, the middle section of the smashing rod is gradually guided into alignment with the axis of the impact block once pressed against the wall of the tapering groove. As soon as a perfect alignment is achieved, the rear section of the smashing rod extends into the striking groove in the impact block such that the impact block is pushed outward by the huge elastic force stored in the compression spring. The impact block strikes the smashing rod and drives the smashing cone to smash the glass obstacle instantly. The rapidly removable protective cover includes a cover base, a sliding sleeve, a packing spring, and a plurality of engaging elements. The cover base is concavely provided with a mounting space and has a closed front end and a rear end formed with a mounting opening. The mounting opening is in communication with the mounting space and matches the outer periphery of the front end of the base of the glass smasher in diameter so that the cover base can be mounted around the outer periphery of the front end of the base, allowing the front end of the base and the smashing cone, which is normally exposed from the front end of the base, to be completely stored in the mounting space, lest the user or any object be punctured or scratched by the smashing cone inadvertently. The cover base is circumferentially formed with a plurality of engaging holes in communication with the mounting space, and each of the engaging elements is movably positioned in a corresponding one of the engaging holes. The sliding sleeve is slidably mounted around the outer periphery of the cover base. The inner wall of the sliding sleeve is circumferentially and protrudingly provided with a packing ring. The packing spring is mounted around the outer periphery of the cover base and is positioned between the cover base and the sliding sleeve. The two ends of the packing spring are pressed respectively against the cover base and the packing ring, in order for the packing ring to push the outer sides of the engaging elements and thereby displace the engaging elements inward of the mounting space through their respective engaging holes, bringing the inner sides of the engaging elements into engagement with the wall of the engaging groove. The rapidly removable protective cover can thus be mounted around the front end of the base both rapidly and securely and is kept from being detached from the front end of the base by accident.

The smashing cone stays exposed from the front end of the glass smasher due to the elastic forces applied by the eccentric spring and by the compression spring, and yet a user needing the service of the smashing cone no more can mount the cover base of the rapidly removable protective cover around the outer periphery of the front end of the base of the glass smasher so that the front end of the base of the glass smasher and the smashing cone exposed from the front end of the base are rapidly and completely stored in the mouthing space in the cover base of the rapidly removable protective cover to effectively protect not only the user but also people and objects near the user from being punctured or scratched by the smashing cone inadvertently. When the user needs to use the smashing cone in an emergency rescue or raid, he or she only has to hold the portable object with one hand, grip the sliding sleeve of the rapidly removable protective cover with the fingers of the other hand, and move forward the sliding sleeve together with the packing ring therein, and the packing ring will no longer push the outer sides of the engaging elements, allowing the engaging elements to displace away from the mounting space through their respective engaging holes and thus rapidly disengage from the engaging groove. The rapidly removable protective cover can then be easily and promptly detached from the front end of the base to expose the smashing cone from the front end of the glass smasher right away so that the user can smash all the glass obstacles encountered in the emergency rescue or raid with the smashing cone.

### BRIEF DESCRIPTION OF THE SEVERAL VIEWS OF THE DRAWINGS

The structural features, method of use, and technical appeals of the present invention can be better understood by referring to the following detailed description of some illustrative embodiments in conjunction with the accompanying drawings, in which:

FIG. 1 schematically shows a conventional tool for use by police officers and firefighters;

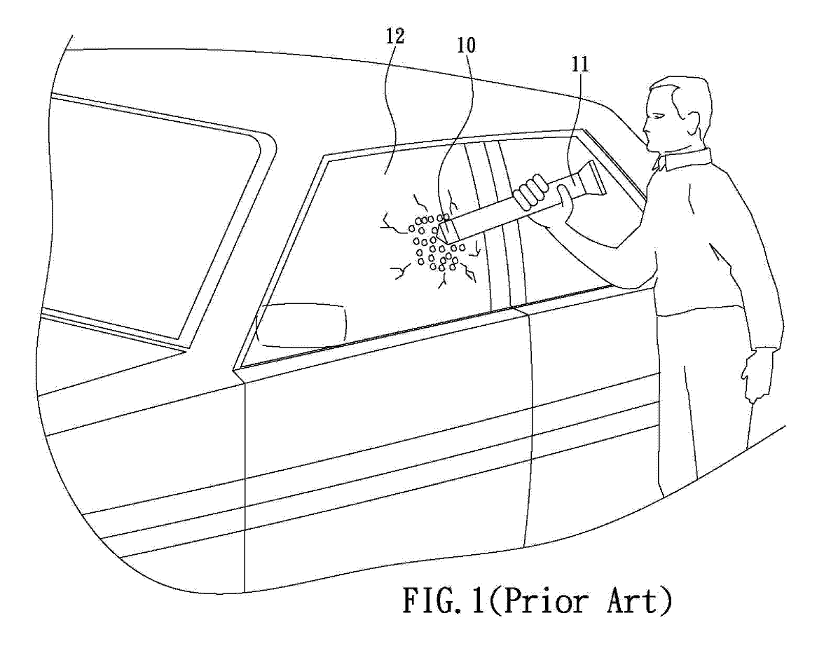

FIG. 2 schematically shows the structure of an expandable baton previously designed and made by the inventor of the present invention;

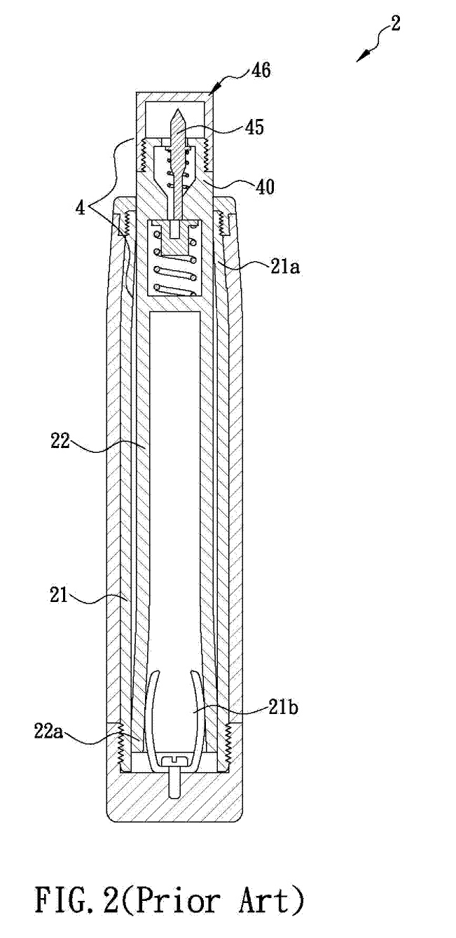

FIG. 3A schematically shows a state of use of the glass smasher at the front end of the inner shaft of the conventional expandable baton in FIG. 2;

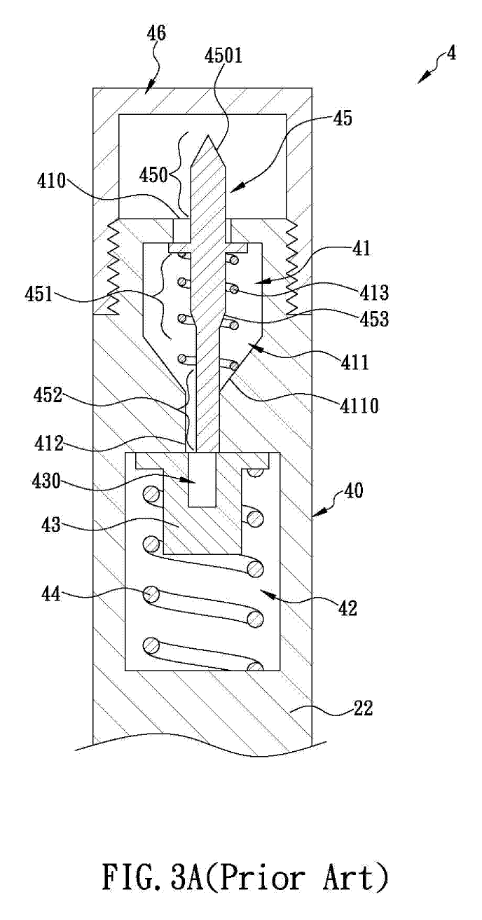

FIG. 3B schematically shows another state of use of the glass smasher at the front end of the inner shaft of the conventional expandable baton in FIG. 2;

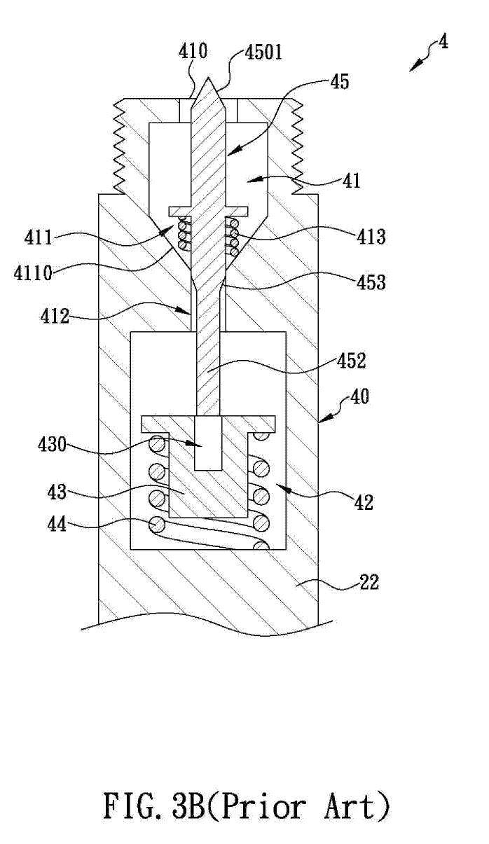

FIG. 4 schematically shows the structure of the glass smasher with a rapidly removable protective cover in the first embodiment of the present invention;

FIG. 5A schematically shows a state of use of the glass smasher in FIG. 4;

FIG. 5B schematically shows another state of use of the glass smasher in FIG. 4;

FIG. 6A schematically shows a state of use of the glass smasher with a rapidly removable protective cover in the second embodiment of the present invention;

FIG. 6B schematically shows another state of use of the glass smasher in FIG. 6A;

FIG. 7A schematically shows a state of use of the glass smasher with a rapidly removable protective cover in the third embodiment of the present invention; and

FIG. 7B schematically shows another state of use of the glass smasher in FIG. 7A.

### DETAILED DESCRIPTION OF THE INVENTION

The present invention provides a glass smasher having a rapidly removable protective cover. The glass smasher is applied to a portable object (e.g., a baton, flashlight, hand tool, or tactical pen) and is mounted at one end of the portable object. Herein, an “expandable baton” is used as the portable object to which the glass smasher is applied, with a view to facilitating comparison with the expandable baton described in BACKGROUND OF THE INVENTION and thereby readily distinguishing the present invention from the prior art in terms of performance.

An expandable baton is used mainly with a swinging action. As stated above, the outer tube of an expandable baton is configured to facilitate gripping and force application. The inner shaft of an expandable baton nevertheless leaves plenty of room for improvement. In the first preferred embodiment of the present invention, the portable object is an expandable baton having the basic structure of several expandable batons previously designed and made by the inventor, and the novel glass smasher structure of the present invention was designed according to this expandable baton. It should be pointed out, however, that the present invention is not necessarily applied to an expandable baton. When implementing the present invention, the glass smasher disclosed herein can be applied to various portable objects such as flashlights, knives, hand tools, and tactical pens, provided that the portable object to be used allows the glass smasher to work in the following manner: when the glass smasher is no longer in use, the cover base of the rapidly removable protective cover can be mounted around the outer periphery of the front end of the base of the glass smasher so that the front end of the base of the glass smasher and the smashing cone exposed from the front end of the base are rapidly and completely stored in the cover base of the rapidly removable protective cover, thus not only allowing the user to carry the portable object around safely and use the particular functions of the portable object whenever needed, but also effectively protecting the user, as well as people and objects nearby, from being punctured or scratched by the otherwise exposed smashing cone on the portable object; and when it is desired to use the smashing cone in an emergency rescue operation or attack, the user only has to hold the portable object with one hand and grip and move forward the sliding sleeve of the rapidly removable protective cover with the fingers of the other hand, and the rapidly removable protective cover can be readily and quickly detached from the front end of the base of the glass smasher, in order to expose the smashing cone from the front end of the glass smasher immediately and thereby break any glass obstacle to be smashed to complete the rescue operation or attack.

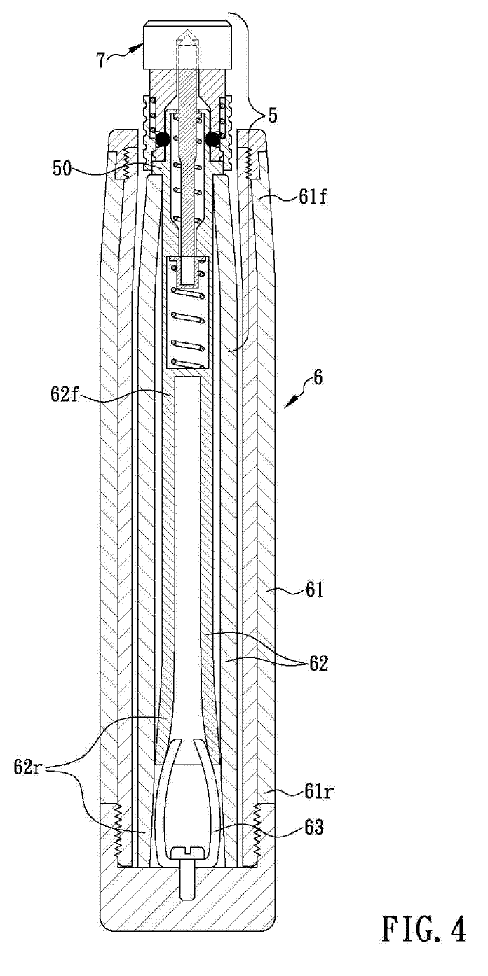

Referring to FIG. 4 for the first preferred embodiment of the present invention, the glass smasher 5 is applied to an expandable baton 6 and is mounted at one end (e.g., the front or rear end) of the expandable baton 6. The expandable baton 6 includes an outer tube 61 and at least one inner shaft 62 (the expandable baton 6 shown in FIG. 4 has two inner shafts 62 by way of example). The outer tube 61 and the inner shaft 62 form the basic structure of the expandable baton 6. The outer tube 61, which may be composed of several elements, has a rear section formed as a handle to be gripped by a user. The outer diameter of the inner shaft 62 is smaller than the inner diameter of the outer tube 61 so that the inner shaft 62 can be moved, and thus mounted, into the outer tube 61 through the rear end 61r of the outer tube 61. In addition, the configuration of the rear end 62r of the inner shaft 62 matches the configuration of a portion of the outer tube 61 that is adjacent to the front end 61f of the outer tube 61. More specifically, the rear end 62r of the inner shaft 62 flares a little while the front end 61f of the outer tube 61 converges slightly to enable engagement between the rear end 62r of the inner shaft 62 and the front end 61f of the outer tube 61. When it is desired to expand the expandable baton 6, the user only has to hold the rear section of the outer tube 61 firmly and swing the expandable baton 6 with force, and the inner shaft 62 will be displaced outward of the front end 61f of the outer tube 61 by the swinging action until the rear end 62r of the inner shaft 62 reaches a position in the outer tube 61 that is adjacent to the front end 61f of the outer tube 61, or more particularly until the outer wall of the rear end 62r of the inner shaft 62 is engaged with the inner wall of the front end 61f of the outer tube 61. As a result, the entire inner shaft 62 is exposed from the front end 61f of the outer tube 61 except for the portion adjacent to the rear end 62r of the inner shaft 62, which portion is now securely engaged in the outer tube 61 at a position adjacent to the front end 61f of the outer tube 61. Conversely, when the expandable baton 6 needs to be used no more, the user only has to strike the front end 62f of the inner shaft 62 against a hard object indirectly (e.g., by first mounting a rapidly removable protective cover 7 around the front end 62f of the inner shaft 62 and then striking the covered front end 62f against the ground), and the inner shaft 62 will be displaced toward the rear end 61r of the outer tube 61 by the reaction force of the striking force and consequently retracted into the outer tube 61. The rear end 62r of the inner shaft 62 will be secured by an engaging member 63 in the rear end 61r of the outer tube 61 such that only the front end of the inner shaft 62 and/or the front end of the base 50 of the glass smasher 5 is exposed from the front end 61f of the outer tube 61.

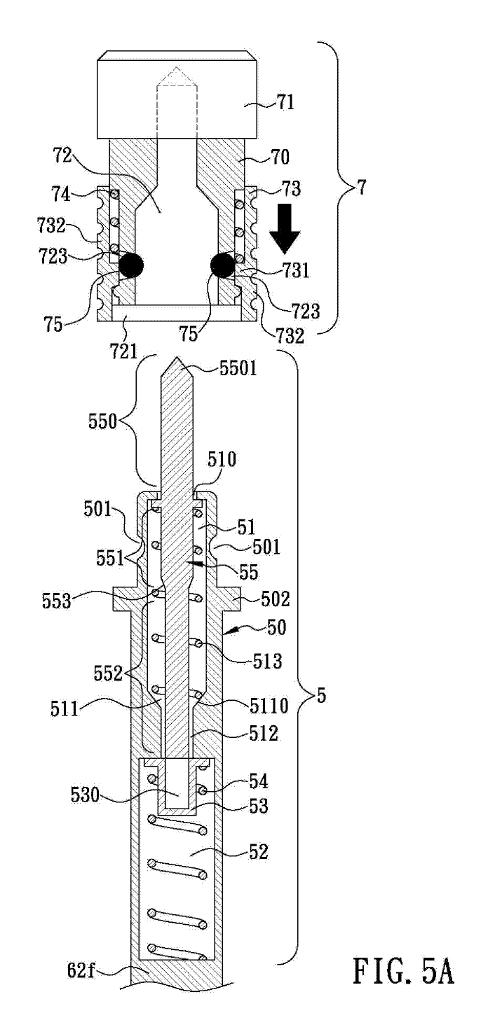

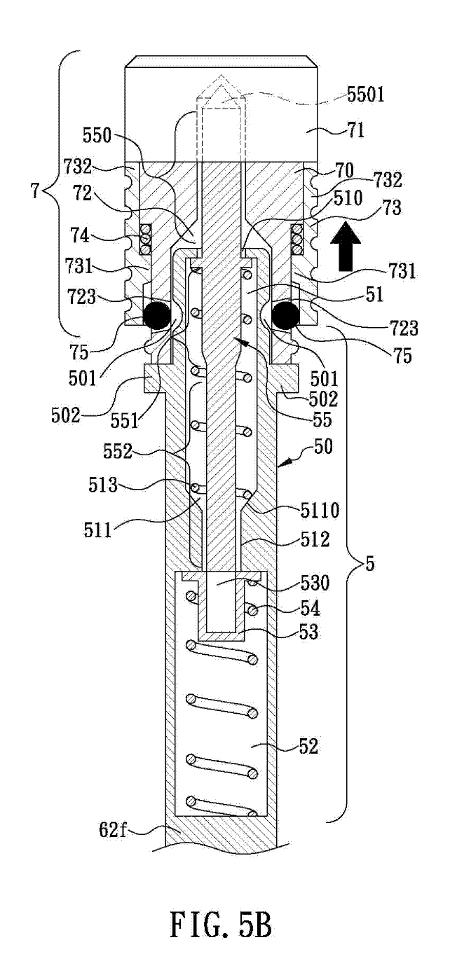

In this embodiment, referring to FIG. 4 and FIG. 5A, the glass smasher 5 includes a base 50, a smashing rod 55, an eccentric spring 513, an impact block 53, and a compression spring 54. The base 50 is coupled to the front end of the expandable baton 6 to form a single unit; in other words, the base 50 is mounted at and coupled to the front end 62f of the inner shaft 62 in such a way that the base 50 and the inner shaft 62 form a single unit. If the expandable baton 6 has plural inner shafts 62, the base 50 is mounted at the front end 62f of the innermost inner shaft 62. An impact groove 51, a tapering groove 511, an aligning groove 512, and a compression force application groove 52 are sequentially formed, in a front-to-rear direction, in the base 50 and the front end 62f of the inner shaft 62 and are in communication with one another. The outer periphery of the base 50 is circumferentially and concavely provided with an annular engaging groove 501 adjacent to the front end of the base 50. The front end of the base 50 is formed with an aperture 510. The aperture 510 is in communication sequentially with the impact groove 51, the tapering groove 511, the aligning groove 512, and the compression force application groove 52 and has a smaller diameter than the impact groove 51. The tapering groove 511 extends taperingly from the rear end of the impact groove 51 to the front end of the aligning groove 512, and the wall of the tapering groove 511 forms a first tapering pressing surface 5110. The diameter of the aligning groove 512 is smaller than those of the impact groove 51 and of the compression force application groove 52.

As shown in FIG. 5A, the impact block 53 is movably positioned in the compression force application groove 52. The front end of the impact block 53 can be pressed against the wall of the compression force application groove 52 (e.g., a portion of the compression force application groove 52 that is adjacent to the aligning groove 512) and is concavely provided with a striking groove 530. The striking groove 530 corresponds to the aligning groove 512 and has a smaller diameter than the aligning groove 512. The compression spring 54 is positioned in the compression force application groove 52 and has its two ends pressed respectively against the rear end of the impact block 53 and a wall portion of the compression force application groove 52 that is away from the aligning groove 512, in order to push the impact block 53 toward the aligning groove 512 and apply a huge elastic force to the impact block 53.

To facilitate description of the structural features and striking principle of the smashing rod 55, the smashing rod 55 is hereinafter divided into a front section 550, a middle section 551, and a rear section 552. Please note that the smashing rod 55 in FIG. 5A and FIG. 5B is depicted in a guided state for the sole purpose of showing the relationship between the smashing rod 55 and the striking groove 530; in practice, the smashing rod 55, when not pushed rearward, is in an eccentric state and will not extend into the striking groove 530. The front section 550 of the smashing rod 55 is formed with a smashing cone 5501. The middle section 551 matches the aligning groove 512 in diameter, and a wall portion of the middle section 551 that is adjacent to the rear section 552 forms a second tapering pressing surface 553. Normally, the axis of the smashing rod 55 is offset from the axis of the impact block 53 such that the rear end of the rear section 552 of the smashing rod 55 is pressed against the front end of the impact block 53 to prevent the rear section 552 of the smashing rod 55 from extending into the striking groove 530. Thus, with the front end of the impact block 53 pushing back at the rear end of the rear section 552 of the smashing rod 55, the smashing rod 55 is positioned in the impact groove 51, the tapering groove 511, and the aligning groove 512, with the smashing cone 5501 exposed from the front end of the glass smasher 5 through the aperture 510.

In this embodiment, with continued reference to FIGS. 4-5B, the eccentric spring 513 is positioned in the impact groove 51 and the tapering groove 511, is mounted around the middle section 551 and the rear section 552 of the smashing rod 55, and has its two ends pressed respectively against a portion of the smashing rod 55 that is adjacent to the front section 550 and the wall of the tapering groove 511, in order to push the smashing rod 55 outward of the aperture 510, thereby exposing the smashing cone 5501 of the front section 550 of the smashing rod 55 from the front end of the glass smasher 5. The elastic force of the eccentric spring 513 must be smaller than that of the compression spring 54 so that, as soon as the rear section 552 of the smashing rod 55 is in alignment with the striking groove 530, the impact block 53 will strike the rear end of the rear section 552 of the smashing rod 55 under the action of the compression spring 54, and when the smashing cone 5501 completes the intended striking and smashing action, the eccentric spring 513 will render the axis of the smashing rod 55 offset from the axis of the impact block 53, thereby moving the rear end of the rear section 552 of the smashing rod 55 away from the striking groove 530 and back to its normal position, i.e., pressed against the front end of the impact block 53.

Referring again to FIG. 4 and FIG. 5A, when a user holding the rear section of the outer tube 61 of the expandable baton 6 presses the smashing cone 5501 forcibly against a to-be-smashed object (e.g., a piece of tempered glass), the smashing rod 55 and the smashing cone 5501 are gradually displaced toward the compression force application groove 52. When a second tapering pressing surface 553 of the wall of the middle section 551 of the smashing rod 55 is pressed against the first tapering pressing surface 5110, the middle section 551 of the smashing rod 55 begins to be guided by the aligning groove 512 into alignment with the axis of the impact block 53. Now that the middle section 551 of the smashing rod 55 matches the aligning groove 512 in diameter, the instant at which the middle section 551 of the smashing rod 55 becomes perfectly aligned with the striking groove 530, the rear section 552 of the smashing rod 55 thrusts into the striking groove 530, allowing the huge elastic force stored in the compression spring 54 to push the impact block 53 outward. The impact block 53 will in turn strike the rear end of the smashing rod 55, thereby driving the smashing cone 5501 at the front end of the smashing rod 55 to smash the to-be-smashed object vigorously. Thus, by equipping the expandable baton 6 with the glass smasher 5, the functions and applications of the expandable baton 6 are greatly increased.

As shown in FIG. 5A, the rapidly removable protective cover 7 in this embodiment includes a cover base 70, a sliding sleeve 73, a packing spring 74, and a plurality of engaging elements 75 (e.g., steel balls or blocks). The cover base 70 is concavely provided with a mounting space 72. The front end 71 of the cover base 70 is closed, whereas the rear end of the cover bae 70 is formed with a mounting opening 721 in communication with the mounting space 72. The diameter of the mounting opening 721 matches that of the outer periphery of the front end of the base 50 of the glass smasher 5 so that the cover base 70 can be mounted around the outer periphery of the front end of the base 50, allowing the front end of the base 50, the front section 550 of the smashing rod 55, and the smashing cone 5501 (the latter two of which are normally exposed from the front end of the base 50) to be completely stored in the mounting space 72, lest a user of the expandable baton 6, or people and objects in the vicinity of the user, be accidentally punctured or scratched by the smashing cone 5501. The cover base 70 is circumferentially formed with a plurality of engaging holes 723 in communication with the mounting space 72, and each engaging element 75 is movably positioned in a corresponding one of the engaging holes 723. The sliding sleeve 73 is mounted around the outer periphery of the cover base 70 and can be slid axially. The inner wall of the sliding sleeve 73 is circumferentially and protrudingly provided with a packing ring 731. The packing spring 74 is mounted around the outer periphery of the cover base 70 and is located between the cover base 70 and the sliding sleeve 73. The two ends of the packing spring 74 are pressed respectively against the cover base 70 and the packing ring 731 in order for the inner side of the packing ring 731 to push the outer sides of the engaging elements 75, thereby displacing the engaging elements 75 inward of the mounting space 72 through the corresponding engaging holes 723 respectively. The inner sides of the engaging elements 75 will end up pressed against the wall of the engaging groove 501, and the rapidly removable protective cover 7 is thus rapidly and securely mounted around the front end of the base 50 and is kept from being detached from the front end of the base 50 inadvertently.

In this embodiment, with continued reference to FIG. 4 and FIG. 5A, the outer periphery of the base 50 is further circumferentially and protrudingly provided with a stop flange 502 adjacent to the front end of the base 50. The stop flange 502 is axially spaced apart from the engaging groove 501. Once the front end of the base 50 and the smashing cone 5501 of the front section 550 of the smashing rod 55, which smashing cone is normally exposed from the front end of the base 50, are completely stored in the mounting space 72 by mounting the cover base 70 around the outer periphery of the front end of the base 50, the end of the cover base 70 that is adjacent to the mounting opening 721 is pressed against the stop flange 502 to prevent the cover base 70 from wobbling.

Thus, even though the smashing cone 5501 of the front section 550 of the smashing rod 55 stays exposed from the front end of the glass smasher 5 due to the elastic forces applied respectively by the eccentric spring 513 and the compression spring 54 to the smashing rod 55, the cover base 70 of the rapidly removable protective cover 7 can be used, when the service of the smashing cone 5501 is no longer needed, to rapidly and completely store the front end of the base 50 of the glass smasher 5 and the smashing cone 5501 exposed from the front end of the base 50, thereby effectively protecting not only the user but also the people and objects nearby from inadvertent puncture or scratch by the smashing cone 5501, and this can be done, referring to FIG. 5A, simply by mounting the cover base 70 of the rapidly removable protective cover 7 axially (in the arrow-indicated direction in FIG. 5A) to the outer periphery of the front end of the base 50 of the glass smasher 5. Conversely, when the smashing cone 5501 is needed in an emergency rescue or raid, referring to FIG. 4 and FIG. 5B, the user only has to hold the expandable baton 6 with one hand, grip the sliding sleeve 73 of the rapidly removable protective cover 7 with the fingers of the other hand, and displace the sliding sleeve 73 axially forward (in the arrow-indicated direction in FIG. 5B) together with the packing ring 731 in the sliding sleeve 73, and the inner side of the packing ring 731 will no longer push the outer sides of the engaging elements 75 but allow the engaging elements 75 to displace away from the mounting space 72 through the corresponding engaging holes 723 respectively and hence disengage from the engaging groove 501. The rapidly removable protective cover 7 can then be easily and swiftly detached from the front end of the base 50 to expose the smashing cone 5501 from the front end of the glass smasher 5 at once, in order for the user to carry out the emergency rescue or raid by breaking glass obstacles with the smashing cone 5501.

In this embodiment, referring back to FIG. 5B, the outer wall of the sliding sleeve 73 is further circumferentially and concavely (or protrudingly) provided with at least one damper ring 732 to increase the friction between the sliding sleeve 73 and the user's fingers gripping the sliding sleeve 73. The damper ring 732 makes it easier for the user to grip the sliding sleeve 73 of the rapidly removable protective cover 7 with fingers and displace the sliding sleeve 73 axially forward (in the arrow-indicated direction in FIG. 5B) so as to disengage the sliding sleeve 73 from the engaging groove 501 and thereby allow the rapidly removable protective cover 7 to be detached from the front end of the base 50 immediately.

In order for the glass smasher 5 in this embodiment to have high and effective smashing power, the smashing cone 5501 of the front section 550 of the smashing rod 55 can be made of spring steel, bearing steel, or the like (or the smashing rod 55 is integrally formed of spring steel or bearing steel), with a view to achieving a Rockwell hardness value of 58 or above, which ensures that the smashing cone 5501 can smash objects made of tempered glass of various grades. Moreover, the longitudinal length of the rear section 552 of the smashing rod 55 is greater than the longitudinal depth of the striking groove 530, and the diameter of the rear section 552 is smaller than that of the striking groove 530. Thus, when the rear section 552 of the smashing rod 55 extends into the striking groove 530 upon alignment therewith, the compression spring 54 can transfer the huge impact energy stored therein to the smashing rod 55 through the impact block 53, thereby enabling the smashing cone 5501 at the front end of the smashing rod 55 to smash objects of various strengths vigorously. Besides, while the base 50 in this embodiment is an independent element coupled to the front end 62f of the expandable baton 6 to form a single unit with the expandable baton 6, the base 50 in another embodiment of the present invention may include a plurality of base portions (e.g., a front base portion and a rear base portion, not shown; or a front base portion, a middle base portion, and a rear base portion, not shown) as appropriate, wherein the base portions are sequentially assembled in sections to form the base 50. That is to say, the “base 50” in the present invention may vary in structure, provided that the impact groove 51, the tapering groove 511, the aligning groove 512, and the compression force application groove 52 are sequentially formed, in a front-to-rear direction, in the base 50 and the front end 62f of the inner shaft 62 and are in communication with one another; that the outer periphery of the base 50 is circumferentially and concavely provided with the engaging groove 501 adjacent to the front end of the base 50; and that the front end of the base 50 is formed with the aperture 510 in communication sequentially with the impact groove 51, the tapering groove 511, the aligning groove 512, and the compression force application groove 52 to enable the smashing function and effect of the glass smasher 5.

In another embodiment of the present invention, the base 50 of the glass smasher 5 may, as appropriate, be provided at the rear end of the outer tube 61 of the expandable baton 6 instead and be coupled to the outer tube 61 such that the base 50 and the outer tube 61 form a single unit. Also, the portable object may, as appropriate, be a tactical pen (not shown) instead, wherein the tactical pen includes a pen barrel configured to be gripped by a user, and wherein the base 50 of the glass smasher 5 is provided at and coupled to one end of the pen barrel such that the base 50 and the pen barrel form a single unit. In yet another embodiment of the present invention, the portable object may alternatively be a hand tool (e.g., a knife) to meet practical needs, wherein the hand tool (e.g., the knife) includes a handle to be gripped by a user and a tool portion (e.g., a blade portion) provided at one end of the handle to provide the corresponding tool function, and wherein the base 50 of the glass smasher 5 is provided at and coupled to the other end of the handle such that the base 50 and the handle form a single unit.

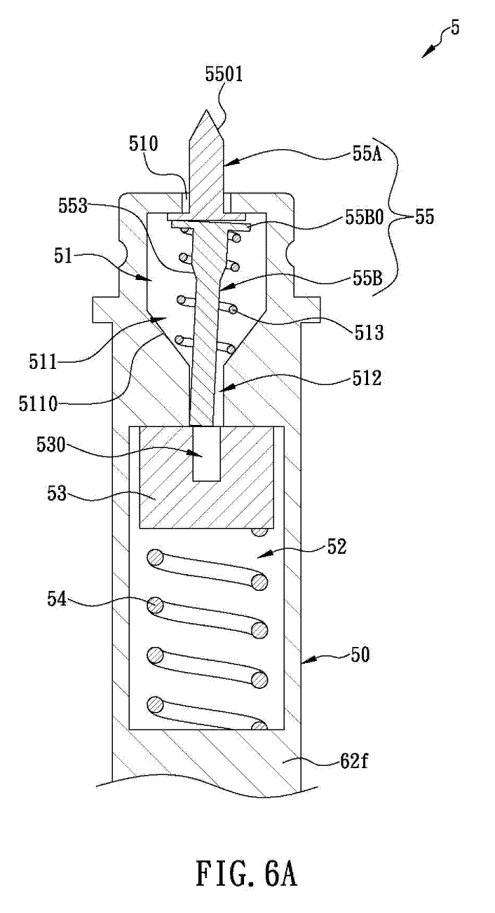

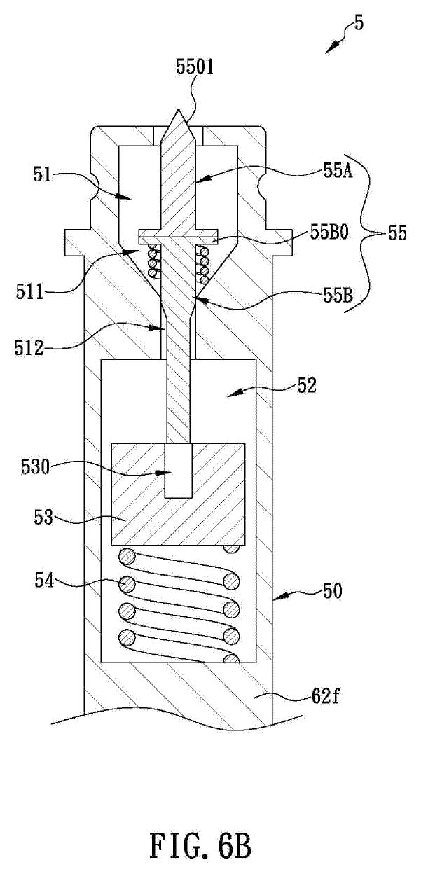

In the second preferred embodiment of the present invention as shown in FIGS. 6A and 6B, the smashing rod 55 is no longer an independent and integrally formed element as in the foregoing embodiment but includes a first smashing rod 55A and a second smashing rod 55B. The smashing rods 55A and 55B may be made of different materials respectively. For example, the first smashing rod 55A is made of spring steel while the second smashing rod 55B is made of a softer material. The first smashing rod 55A is equivalent to the “front section 550” in the previous embodiment (see FIG. 5A), and the second smashing rod 55B, to the “middle section 551 and rear section 552” in the previous embodiment. The two ends of the eccentric spring 513 are pressed respectively against the second smashing rod 55B (e.g., a shoulder portion 55B0 protrudingly provided at the front end of the second smashing rod 55B) and the wall of the tapering groove 511. The front end of the second smashing rod 55B is configured to push the rear end of the first smashing rod 55A toward the aperture 510 and thereby displace the front end of the first smashing rod 55A outward of the aperture 510, exposing the smashing cone 5501 at the front end of the first smashing rod 55A from the front end of the glass smasher 5 through the aperture 510. This “two-section” structure of the smashing rod 55 is so designed that the first smashing rod 55A is not integrally formed with but is to be pushed outward by the second smashing rod 55B. Therefore, even though the second smashing rod 55B is tilted (as shown in FIG. 6A, in which the axis of the second smashing rod 55B is offset from that of the impact block 53) while the smashing cone 5501 at the front end of the first smashing rod 55A is not pressed against any object to be smashed, the axis of the first smashing rod 55A can stay parallel to that of the impact block 53, allowing the smashing cone 5501 at the front end of the first smashing rod 55A to be exposed perpendicularly from the front end of the glass smasher 5 through the aperture 510. This not only gives the glass smasher 5 a neat and visually pleasing look, but also makes it easier for a user to aim the smashing cone 5501 precisely at a smashing point on a to-be-smashed glass obstacle in front of the smashing rod 55, break the glass obstacle by striking the same point repeatedly, and thereby achieve success in an emergency rescue or raid.

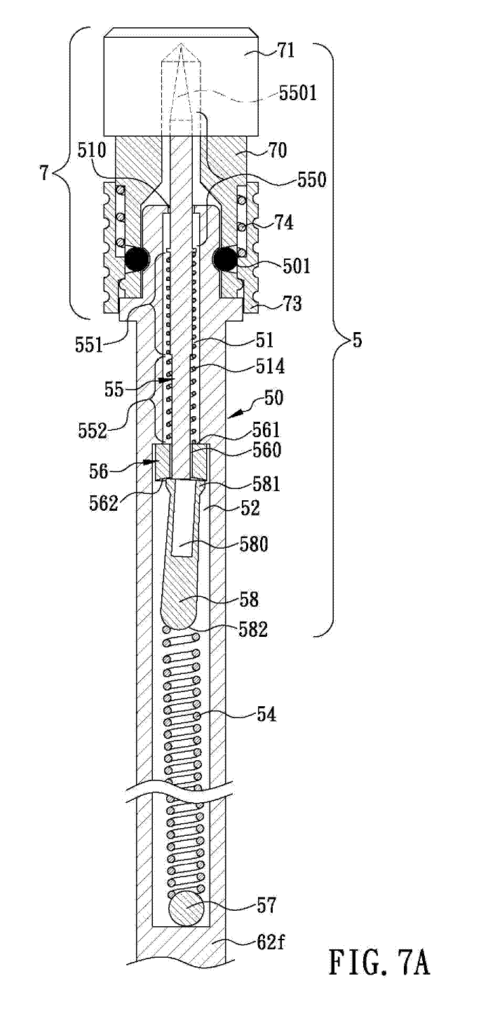

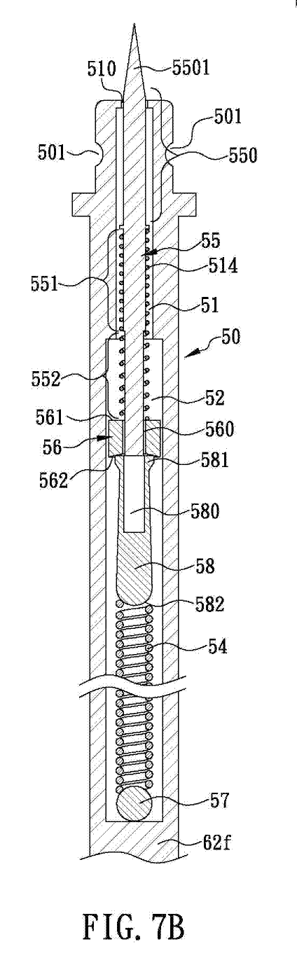

Furthermore, to effectively simplify the internal structure of the base 50 of the glass smasher 5 in each of the foregoing embodiments, the glass smasher 5 may, as appropriate, be structured as shown in FIG. 7A and FIG. 7B, which show the third preferred embodiment of the present invention. In the third preferred embodiment, the glass smasher 5 includes a base 50, a smashing rod 55, a guide spring 514, a guide block 56, an offset striking block 58, a compression spring 54, and a guiding steel ball 57. The base 50 is coupled to the front end of the expandable baton 6 to form a single unit, meaning the base 50 is mounted at and coupled to the front end 62f of the inner shaft 62 such that the base 50 and the inner shaft 62 form a single unit. If the expandable baton 6 has several inner shafts 62, the base 50 is mounted at the front end 62f of the innermost inner shaft 62. An impact groove 51 and a compression force application groove 52 are sequentially formed, in a front-to-rear direction, in the base 50 and the front end 62f of the inner shaft 62 and are in communication with each other. The outer periphery of the base 50 is circumferentially and concavely provided with an annular engaging groove 501 adjacent to the front end of the base 50. The front end of the base 50 is formed with an aperture 510, which is in communication sequentially with the impact groove 51 and the compression force application groove 52, and whose diameter is smaller than those of the impact groove 51 and of the compression force application groove 52.

To facilitate description of the structural features and striking principle of the smashing rod 55 in this embodiment, the smashing rod 55 is also divided into a front section 550, a middle section 551, and a rear section 552, as shown in FIG. 7A and FIG. 7B. The guide spring 514 is mounted around the smashing rod 55 at a position adjacent to the middle section 551 and the rear section 552. The front end of the guide spring 514 is pressed against a portion of the smashing rod 55 that is adjacent to the front section 550. The rear end of the guide spring 514 is pressed against a front-end wall 561 of the guide block 56. The guide block 56 is movably positioned in the compression force application groove 52. The front-end wall 561 of the guide block 56 can be pressed against the wall of the compression force application groove 52 (e.g., a portion of the compression force application groove 52 that is adjacent to the impact groove 51) and is concavely provided with a guide groove 560. The guide block 56 is so designed that, once the rear section 552 of the smashing rod 55 passes through the guide groove 560, the rear end of the smashing rod 55 is pressed against a front-end side 581 of the offset striking block 58. The offset striking block 58 is movably positioned in the compression force application groove 52. The front-end side 581 of the offset striking block 58 can be pressed against a rear-end wall 562 of the guide block 56 and is concavely provided with an offset striking groove 580 corresponding to the guide groove 560. The front-end wall 561 or the rear-end wall 562 of the guide block 56 forms a curved guide surface (e.g., a central portion of the front-end wall 561 or of the rear-end wall 562 of the guide block 56 has a curved surface adjacent to the guide groove 560). The compression spring 54 is positioned in the compression force application groove 52. The front end of the compression spring 54 is pressed against a rear-end side 582 of the offset striking block 58. The front-end side 581 or the rear-end side 582 of the offset striking block 58 forms a curved guide surface (e.g., a central portion of the front-end side 581 or of the rear-end side 582 of the offset striking block 58 has a curved surface adjacent to the offset striking groove 580). The rear end of the compression spring 54 is pressed against the guiding steel ball 57, in order for the compression spring 54 to push the offset striking block 58 toward the impact groove 51 and apply a huge elastic force to the offset striking block 58. The guiding steel ball 57 is pushed by the compression spring 54 against a wall portion of the compression force application groove 52 that is away from the impact groove 51, but the guiding steel ball 57 can still be displaced or rolled. Therefore, while the compression spring 54 is being compressed, the guiding steel ball 57 and the curved guide surface of the front-end wall 561 or of the rear-end wall 562 of the guide block 56 or the curved guide surface of the front-end side 581 or of the rear-end side 582 of the offset striking block 58 can fine-tune the positions of the compression spring 54 and of the offset striking block 58, thereby bringing the offset striking groove 580 in the offset striking block 58 into alignment with the guide groove 560, allowing the rear section 552 of the smashing rod 55 to be guided into the offset striking groove 580 immediately after the rear section 552 extends through the guide groove 560. Since either the curved guide surface of the front-end wall 561 or of the rear-end wall 562 of the guide block 56 or the curved guide surface of the front-end side 581 or of the rear-end side 582 of the offset striking block 58 is sufficient in itself to fine-tune the positions of the compression spring 54 and of the offset striking block 58, to bring the offset striking groove 580 in the offset striking block 58 into alignment with the guide groove 560, and to thereby allow the rear section 552 of the smashing rod 55 to be guided into the offset striking groove 580 immediately after the rear section 552 extends through the guide groove 560, the guiding steel ball 57 can be dispensed with in other embodiments of the present invention, with a view to structural simplicity and ease of assembly.

It is worth mentioning that, while the front-end wall 561 of the guide block 56 in the embodiment shown in FIG. 7A is expected to be pressed against the wall of the compression force application groove 52 (e.g., a portion of the compression force application groove 52 that is adjacent to the impact groove 51), the guide spring 514 in another embodiment of the present invention can be so strong that the front-end wall 561 of the guide block 56 will not be pressed against the wall of the compression force application groove 52. In such cases, the interior of the base 50 can be designed as a straight tubular hollow, without forming a shoulder that is located in the compression force application groove 52 at a position adjacent to the impact groove 51 and that extends toward the central axis of the base 50.

In FIG. 7B, the smashing rod 55 is depicted in the aligned state for the sole purpose of showing the relationship between the smashing rod 55 and the offset striking groove 580 right before the smashing cone 5501 of the front section 550 of the smashing rod 55 smashes a glass obstacle. In practice, referring back to FIG. 7A, the rear section 552 of the smashing rod 55 is offset from and hence will not extend into the offset striking groove 580 before the front section 550 of the smashing rod 55 is pushed inward by a glass obstacle. The front section 550 of the smashing rod 55 is formed with the smashing cone 5501, and the middle section 551 and the rear section 552 of the smashing rod 55 match the guide groove 560 in diameter so that, once the rear section 552 of the smashing rod 55 extends through the guide groove 560, the axis of the smashing rod 55 is offset from the axis of the offset striking block 58, with the rear end of the rear section 552 of the smashing rod 55 pressed against the front-end side 581 of the offset striking block 58 to prevent the rear section 552 of the smashing rod 55 from extending into the offset striking groove 580. The front-end side 581 of the offset striking block 58 can therefore push the rear end of the rear section 552 of the smashing rod 55, thereby positioning the smashing rod 55 in the impact groove 51 and the compression force application groove 52 while exposing the front section 550 of the smashing rod 55 and the smashing cone 5501 from the front end of the glass smasher 5 through the aperture 510.

In the third embodiment, with continued reference to FIGS. 7A and 7B, the guide spring 514 is positioned in the impact groove 51 and is mounted around the smashing rod 55 at a position adjacent to the middle section 551 and the rear section 552. Moreover, the two ends of the guide spring 514 are pressed respectively against a portion of the smashing rod 55 that is adjacent to the front section 550 and the front-end wall 561 of the guide block 56, in order for the guide spring 514 to push the smashing rod 55 outward of the aperture 510, thereby exposing the smashing cone 5501 of the front section 550 of the smashing rod 55 from the front end of the glass smasher 5. The elastic force of the guide spring 514 must be smaller than that of the compression spring 54 so that, once the rear end of the rear section 552 of the smashing rod 55 is fine-tuned into alignment with the offset striking groove 580, the front-end side 581 of the offset striking block 58 will strike the rear end of the rear section 552 of the smashing rod 55 under the action of the compression spring 54, and when the smashing cone 5501 completes the intended striking and smashing action on a glass obstacle, the guide spring 514 and the curved guide surface of the front-end wall 561 or of the rear-end wall 562 of the guide block 56 will render the axis of the smashing rod 55 offset from the axis of the offset striking block 58, thereby moving the rear end of the rear section 552 of the smashing rod 55 away from the offset striking groove 580 and back to its normal position, i.e., pressed against the front-end side 581 of the offset striking block 58 to wait for the next striking operation.

While the invention herein disclosed has been described by means of specific embodiments, numerous modifications and variations could be made thereto by those skilled in the art without departing from the scope of the invention set forth in the claims.

What is claimed is:

1. A glass smasher with a rapidly removable protective cover, comprising:
the glass smasher, mounted at an end of a portable object and comprising:
a base coupled to the end of the portable object such that the base and the portable object form a single unit, wherein the base has a front end formed with an aperture; the base has an outer periphery circumferentially and concavely provided with an engaging groove adjacent to the front end of the base; an impact groove, a tapering groove, an aligning groove, and a compression force application groove are sequentially formed, in a front-to-rear direction, in the base such that the aperture is in communication with the impact groove, the tapering groove, the aligning groove, and the compression force application groove sequentially; the aperture has a smaller diameter than the impact groove; the tapering groove extends taperingly from a rear end of the impact groove to a front end of the aligning groove and has a wall forming a first tapering pressing surface; and the aligning groove has a smaller diameter than the impact groove and the compression force application groove;
a smashing rod having a front section formed with a smashing cone, a middle section matching the aligning groove in diameter, and a rear section, wherein the middle section has a wall forming a second tapering pressing surface adjacent to the rear section;
an eccentric spring mounted around a periphery of the middle section of the smashing rod and forcing an axis of the smashing rod to be offset from an axis of an impact block such that a rear end of the rear section of the smashing rod is pressed against a front end of the impact block, preventing the rear section of the smashing rod from extending into a striking groove;
the impact block, movably positioned in the compression force application groove, wherein the front end of the impact block is able to be pressed against a wall of the compression force application groove and is concavely provided with the striking groove, the striking groove corresponds to the aligning groove, and the striking groove has a smaller diameter than the aligning groove; and
a compression spring positioned in the compression force application groove and having two ends pressed respectively against a rear end of the impact block and a wall portion of the compression force application groove that is away from the aligning groove, in order to push the impact block toward the aligning groove and thus push the front end of the impact block against the rear end of the rear section of the smashing rod, thereby positioning the smashing rod in the impact groove, the tapering groove, and the aligning groove, with the smashing cone exposed from a front end of the glass smasher through the aperture, wherein when the smashing cone is pressed forcibly against a to-be-smashed object, the smashing rod is gradually displaced toward the compression force application groove; when the second tapering pressing surface of the wall of the middle section of the smashing rod is consequently pressed against the first tapering pressing surface, the middle section of the smashing rod begins to be guided by the aligning groove into alignment with the axis of the impact block; and as soon as the middle section of the smashing rod is in perfect alignment with the striking groove, the rear section of the smashing rod extends into the striking groove such that the impact block is forced outward by a huge elastic force stored in the compression spring and strikes a rear end of the smashing rod, thereby driving the smashing cone at a front end of the smashing rod to smash the to-be-smashed object forcibly; and
the rapidly removable protective cover, comprising:
a cover base concavely provided with a mounting space, wherein the cover base has a closed front end and a rear end formed with a mounting opening; the mounting opening is in communication with the mounting space and matches the outer periphery of the front end of the base in diameter so that the cover base is able to be mounted around the outer periphery of the front end of the base, allowing the front end of the base and the smashing cone of the front section of the smashing rod, which smashing cone is normally exposed from the front end of the base, to be completely stored and hidden in the mounting space; and the cover base is circumferentially formed with a plurality of engaging holes in communication with the mounting space;
a sliding sleeve mounted around an outer periphery of the cover base in an axially slidable manner, wherein the sliding sleeve has an inner wall circumferentially and protrudingly provided with a packing ring;
a packing spring mounted around the outer periphery of the cover base and positioned between the cover base and the sliding sleeve, wherein the packing spring has two ends pressed respectively against the cover base and the packing ring; and
a plurality of engaging elements each movably positioned in a corresponding one of the engaging holes, wherein the packing spring causes the packing ring to push outer sides of the engaging elements such that the engaging elements are displaced inward of the mounting space through the corresponding engaging holes respectively, bringing inner sides of the engaging elements into engagement with a wall of the engaging groove, thereby securing the protective cover at the front end of the base against inadvertent detachment from the front end of the base.

2. The glass smasher of claim 1, wherein the front end of the impact block is able to be pressed against a wall portion of the compression force application groove that is adjacent to the aligning groove.

3. The glass smasher of claim 2, wherein the outer periphery of the base is circumferentially and protrudingly provided with a stop flange adjacent to the front end of the base; the stop flange is axially spaced apart from the engaging groove; and when the cover base is mounted around the outer periphery of the front end of the base such that the front end of the base and the smashing cone of the front section of the smashing rod, which smashing cone is normally exposed from the front end of the base, are completely stored and hidden in the mounting space, a said end of the cover base that is adjacent to the mounting opening is pressed against the stop flange to keep the cover base from wobbling.

4. The glass smasher of claim 3, wherein the sliding sleeve has an outer wall circumferentially and concavely provided with at least one damper ring to increase friction between the sliding sleeve and fingers gripping the sliding sleeve.

5. The glass smasher of claim 4, wherein the rear section of the smashing rod has a longitudinal length greater than a longitudinal depth of the striking groove.

6. The glass smasher of claim 5, wherein the smashing rod comprises a first smashing rod and a second smashing rod, and the eccentric spring has two ends pressed respectively against the second smashing rod and the wall of the tapering groove such that a front end of the second smashing rod pushes a rear end of the first smashing rod outward of the aperture, thereby exposing the smashing cone at a front end of the first smashing rod from the front end of the glass smasher through the aperture.

7. The glass smasher of claim 6, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at the front end of the inner shaft and is coupled to the inner shaft such that the base and the inner shaft form a single unit.

8. The glass smasher of claim 6, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at a rear end of the outer tube and is coupled to the outer tube such that the base and the outer tube form a single unit.

9. The glass smasher of claim 6, wherein the portable object is a tactical pen comprising a pen barrel, the pen barrel is configured to be gripped by a user, and the base of the glass smasher is provided at an end of the pen barrel and is coupled to the pen barrel such that the base and the pen barrel form a single unit.

10. The glass smasher of claim 6, wherein the portable object is a hand tool comprising a tool portion and a handle, the tool portion is provided at an end of the handle to provide a corresponding tool function, the handle is configured to be gripped by a user, and the glass smasher is provided at an opposite end of the handle and is coupled to the handle such that the glass smasher and the handle form a single unit.

11. A glass smasher with a rapidly removable protective cover, comprising:
the glass smasher, mounted at an end of a portable object and comprising:
a base coupled to the end of the portable object such that the base and the portable object form a single unit, wherein the base has a front end formed with an aperture; the base has an outer periphery circumferentially and concavely provided with an engaging groove adjacent to the front end of the base; an impact groove and a compression force application groove are sequentially formed, in a front-to-rear direction, in the base such that the aperture is in communication with the impact groove and the compression force application groove sequentially; and the aperture has a smaller diameter than the impact groove and the compression force application groove;
a smashing rod having a front section with a front end formed with a smashing cone;
a guide spring mounted around a periphery of the smashing rod at a position adjacent to a middle section and a rear section of the smashing rod, wherein the guide spring has a front end pressed against a portion of the smashing rod that is adjacent to the front section of the smashing rod, thereby forcing an axis of the smashing rod to be offset from an axis of the compression force application groove, pushing the smashing rod outward of the aperture, and consequently exposing the smashing cone of the front section of the smashing rod from a front end of the glass smasher;
a guide block movably positioned in the compression force application groove, wherein the guide block has a front-end wall able to be pressed at least against a rear end of the guide spring, the front-end wall of the guide block is concavely provided with a guide groove, the guide groove matches the middle section and the rear section of the smashing rod in diameter so that a rear end of the smashing rod is able to extend through the guide groove, and the guide block has a front-end wall and a rear-end wall, either of which forms a curved guide surface;
an offset striking block movably positioned in the compression force application groove, wherein the offset striking block has a front-end side pressed against the rear-end wall of the guide block and concavely provided with a striking groove corresponding to the guide groove such that, once extending through the guide groove, the rear end of the smashing rod is pressed against the front-end side of the offset striking block to prevent the rear section of the smashing rod from extending into the striking groove; and
a compression spring positioned in the compression force application groove, wherein the compression spring has a front end pressed against a rear-end side of the offset striking block;
wherein the compression spring is able to push the offset striking block toward the impact groove so that the front-end side of the offset striking block pushes the rear end of the smashing rod, thereby positioning the smashing rod in the impact groove and the compression force application groove, with the smashing cone exposed from the front end of the glass smasher through the aperture; when the smashing cone is pressed forcibly against a to-be-smashed object, the smashing rod is gradually displaced toward the compression force application groove, and the rear section of the smashing rod is gradually guided by the guide groove into alignment with an axis of the offset striking block; and when in perfect alignment with the striking groove, the rear end of the smashing rod extends into the striking groove instantly such that the offset striking block is forced outward by a huge elastic force stored in the compression spring and strikes the rear end of the smashing rod, thereby driving the smashing cone at a front end of the smashing rod to smash the to-be-smashed object forcibly; and
the rapidly removable protective cover, comprising:
a cover base concavely provided with a mounting space, wherein the cover base has a closed front end and a rear end formed with a mounting opening; the mounting opening is in communication with the mounting space and matches the outer periphery of the front end of the base in diameter so that the cover base is able to be mounted around the outer periphery of the front end of the base, allowing the front end of the base and the smashing cone of the front section of the smashing rod, which smashing cone is normally exposed from the front end of the base, to be completely stored and hidden in the mounting space; and the cover base is circumferentially formed with a plurality of engaging holes in communication with the mounting space;
a sliding sleeve mounted around an outer periphery of the cover base in an axially slidable manner, wherein the sliding sleeve has an inner wall circumferentially and protrudingly provided with a packing ring;
a packing spring mounted around the outer periphery of the cover base and positioned between the cover base and the sliding sleeve, wherein the packing spring has two ends pressed respectively against the cover base and the packing ring; and
a plurality of engaging elements each movably positioned in a corresponding one of the engaging holes, wherein the packing spring causes the packing ring to push outer sides of the engaging elements such that the engaging elements are displaced inward of the mounting space through the corresponding engaging holes respectively, bringing inner sides of the engaging elements into engagement with a wall of the engaging groove, thereby securing the protective cover at the front end of the base against inadvertent detachment from the front end of the base.

12. The glass smasher of claim 11, further comprising a guiding steel ball pressed against a rear end of the compression spring and also against a wall portion of the compression force application groove that is away from the impact groove so that the compression spring is able to push the offset striking block toward the impact groove and apply the huge elastic force to the offset striking block, wherein while the compression spring is being compressed, the guiding steel ball is displaceable or rollable to fine-tune the compression spring and the offset striking block in position, in order for the striking groove in the offset striking block to correspond to the guide groove so that, once extending through the guide groove, the rear end of the smashing rod extends into the striking groove instantly under guidance of the guide groove.

13. The glass smasher of claim 11, wherein the front-end side or the rear-end side of the offset striking block forms a curved guide surface, and the curved guide surface of the front-end side or of the rear-end side of the offset striking block or the curved guide surface of the front-end wall or of the rear-end wall of the guide block is sufficient to fine-tune the compression spring and the offset striking block in position, in order for the striking groove in the offset striking block to be in alignment with and correspond to the guide groove so that, once extending through the guide groove, the rear section of the smashing rod extends into the striking groove instantly under guidance of the guide groove.

14. The glass smasher of claim 11, wherein a front end of the guide block is able to be pressed against a wall portion of the compression force application groove that is adjacent to the impact groove.

15. The glass smasher of claim 12, wherein a front end of the guide block is able to be pressed against a wall portion of the compression force application groove that is adjacent to the impact groove.

16. The glass smasher of claim 13, wherein a front end of the guide block is able to be pressed against a wall portion of the compression force application groove that is adjacent to the impact groove.

17. The glass smasher of claim 14, wherein the outer periphery of the base is circumferentially and protrudingly provided with a stop flange adjacent to the front end of the base; the stop flange is axially spaced apart from the engaging groove; and when the cover base is mounted around the outer periphery of the front end of the base such that the front end of the base and the smashing cone of the front section of the smashing rod, which smashing cone is normally exposed from the front end of the base, are completely stored and hidden in the mounting space, a said end of the cover base that is adjacent to the mounting opening is pressed against the stop flange to keep the cover base from wobbling.

18. The glass smasher of claim 15, wherein the outer periphery of the base is circumferentially and protrudingly provided with a stop flange adjacent to the front end of the base; the stop flange is axially spaced apart from the engaging groove; and when the cover base is mounted around the outer periphery of the front end of the base such that the front end of the base and the smashing cone of the front section of the smashing rod, which smashing cone is normally exposed from the front end of the base, are completely stored and hidden in the mounting space, a said end of the cover base that is adjacent to the mounting opening is pressed against the stop flange to keep the cover base from wobbling.

19. The glass smasher of claim 16, wherein the outer periphery of the base is circumferentially and protrudingly provided with a stop flange adjacent to the front end of the base; the stop flange is axially spaced apart from the engaging groove; and when the cover base is mounted around the outer periphery of the front end of the base such that the front end of the base and the smashing cone of the front section of the smashing rod, which smashing cone is normally exposed from the front end of the base, are completely stored and hidden in the mounting space, a said end of the cover base that is adjacent to the mounting opening is pressed against the stop flange to keep the cover base from wobbling.

20. The glass smasher of claim 17, wherein the sliding sleeve has an outer wall circumferentially and concavely provided with at least one damper ring to increase friction between the sliding sleeve and fingers gripping the sliding sleeve.

21. The glass smasher of claim 18, wherein the sliding sleeve has an outer wall circumferentially and concavely provided with at least one damper ring to increase friction between the sliding sleeve and fingers gripping the sliding sleeve.

22. The glass smasher of claim 19, wherein the sliding sleeve has an outer wall circumferentially and concavely provided with at least one damper ring to increase friction between the sliding sleeve and fingers gripping the sliding sleeve.

23. The glass smasher of claim 20, wherein the rear section of the smashing rod has a longitudinal length greater than a longitudinal depth of the striking groove.

24. The glass smasher of claim 21, wherein the rear section of the smashing rod has a longitudinal length greater than a longitudinal depth of the striking groove.

25. The glass smasher of claim 22, wherein the rear section of the smashing rod has a longitudinal length greater than a longitudinal depth of the striking groove.

26. The glass smasher of claim 23, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at the front end of the inner shaft and is coupled to the inner shaft such that the base and the inner shaft form a single unit.

27. The glass smasher of claim 24, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at the front end of the inner shaft and is coupled to the inner shaft such that the base and the inner shaft form a single unit.

28. The glass smasher of claim 25, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at the front end of the inner shaft and is coupled to the inner shaft such that the base and the inner shaft form a single unit.

29. The glass smasher of claim 23, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at a rear end of the outer tube and is coupled to the outer tube such that the base and the outer tube form a single unit.

30. The glass smasher of claim 24, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at a rear end of the outer tube and is coupled to the outer tube such that the base and the outer tube form a single unit.

31. The glass smasher of claim 25, wherein the portable object is an expandable baton comprising an outer tube and at least one inner shaft, the outer tube is configured to be gripped by a user, the inner shaft is retractable into the outer tube so that only a front end of the inner shaft is exposed from a front end of the outer tube, and the base of the glass smasher is provided at a rear end of the outer tube and is coupled to the outer tube such that the base and the outer tube form a single unit.

32. The glass smasher of claim 23, wherein the portable object is a tactical pen comprising a pen barrel, the pen barrel is configured to be gripped by a user, and the base of the glass smasher is provided at an end of the pen barrel and is coupled to the pen barrel such that the base and the pen barrel form a single unit.

33. The glass smasher of claim 24, wherein the portable object is a tactical pen comprising a pen barrel, the pen barrel is configured to be gripped by a user, and the base of the glass smasher is provided at an end of the pen barrel and is coupled to the pen barrel such that the base and the pen barrel form a single unit.

34. The glass smasher of claim 25, wherein the portable object is a tactical pen comprising a pen barrel, the pen barrel is configured to be gripped by a user, and the base of the glass smasher is provided at an end of the pen barrel and is coupled to the pen barrel such that the base and the pen barrel form a single unit.

35. The glass smasher of claim 23, wherein the portable object is a hand tool comprising a tool portion and a handle, the tool portion is provided at an end of the handle to provide a corresponding tool function, the handle is configured to be gripped by a user, and the glass smasher is provided at an opposite end of the handle and is coupled to the handle such that the glass smasher and the handle form a single unit.

36. The glass smasher of claim 24, wherein the portable object is a hand tool comprising a tool portion and a handle, the tool portion is provided at an end of the handle to provide a corresponding tool function, the handle is configured to be gripped by a user, and the glass smasher is provided at an opposite end of the handle and is coupled to the handle such that the glass smasher and the handle form a single unit.

37. The glass smasher of claim 25, wherein the portable object is a hand tool comprising a tool portion and a handle, the tool portion is provided at an end of the handle to provide a corresponding tool function, the handle is configured to be gripped by a user, and the glass smasher is provided at an opposite end of the handle and is coupled to the handle such that the glass smasher and the handle form a single unit.
